(19) United States
(12) Patent Application Publication
(10) Pub. No.: US 2006/0221406 A1
(43) Pub. Date: Oct. 5, 2006

(54) Image processing in machine vision systems

(76) Inventors: Padraig Aiden Andrew Butler, Athlone (IE); Anthony Peter Thomas Mapstone, Dublin (IE); James Mahon, Dublin (IE)

Correspondence Address: PERMAN & GREEN, 425 POST ROAD, FAIRFIELD, CT, 06824, US

(21) Appl. No.: 11/364,790

(22) Filed: Feb. 28, 2006

(30) Foreign Application Priority Data
Mar. 30, 2005 (GB) 0506372.2

(51) Int. Cl. H04N 1/40

(52) U.S. Cl. 358/447; 358/448

(57) ABSTRACT

Images are captured of linear illumination with improved identification of lines and elimination of noise. A most probable line of multiple lines is identified as the one which is widest, and two parallel lines in proximity are regarded as one if their separation is two or one dark pixels. There is an upper line width limit, to eliminate blooming.

The invention relates to processing of images in a machine vision system in which there is linear illumination. An example is a system for measuring 3D parameters using triangulation.

At present, it is known to use a CMOS or CCD camera to both capture such images and to process them using an on-board processor such as an FPGA. While such an arrangement is very fast, there are typically several problems such as:
inclusion of extraneous reflections or other noise in a processed image of a line,
biasing of the average line position,
inclusion of outliers,
processing of noise arising from specular reflections, and
lack of ability to differentiate between sharp lines parallel to and in close proximity to each other.

To illustrate, Fig. A shows examples of (a) split line, (b) blooming, and (c) scattered light. Such effects can have a negative impact on inspection results.

The invention addresses these problems.

### SUMMARY OF INVENTION

According to the invention, there is provided an image processor for capturing camera sensor signals and identifying patterns of illumination on a target, wherein the processor identifies a most probable illumination line from a plurality of lines which include spectral reflections from surfaces adjacent to a central line of illumination.

In one embodiment, the processor identifies as most probable the line of pixels, which is the widest.

In another embodiment, the processor imposes upper and lower limits on line width.

In a further embodiment, said limits are configurable.

In one embodiment, the upper limit is set to eliminate blooming.

In another embodiment, the processor determines a gap between parallel lines separated by dark pixels and processes two parallel lines as a single line if the distance between them is below a threshold.

In a further embodiment, the threshold is two dark pixels.

In one embodiment, the processor compares pixel values against a threshold to identify a line.

In another embodiment, the processor varies the threshold across the field of view.

In a further embodiment, the threshold is a function of a dimension of the field of view.

In one embodiment, the threshold is varied by adding a compensation value according to a dimension value.

In another embodiment, the threshold is increased or reduced closer to the centroid of a line.

In a further embodiment, the processor compares pixel values against lower and upper thresholds.

In one embodiment, results of one or both comparisons are used in centroid calculations.

In another embodiment, pixels above the upper threshold are used in the centroid calculations in preference if there are sufficient such pixels.

In a further embodiment, the processor eliminates outlier pixels by:
keeping track of an average pixel level, and
comparing a pixel value with the average level to estimate if it is an outlier.

In another aspect, the invention provides a machine vision system comprising:
an illuminator for directing linear illumination at a target,
a camera, and
an image processor of any preceding claim connected to the camera.

### DETAILED DESCRIPTION OF THE INVENTION

The invention will be more clearly understood from the following description of some embodiments thereof, given by way of example only with reference to the accompanying drawings in which:

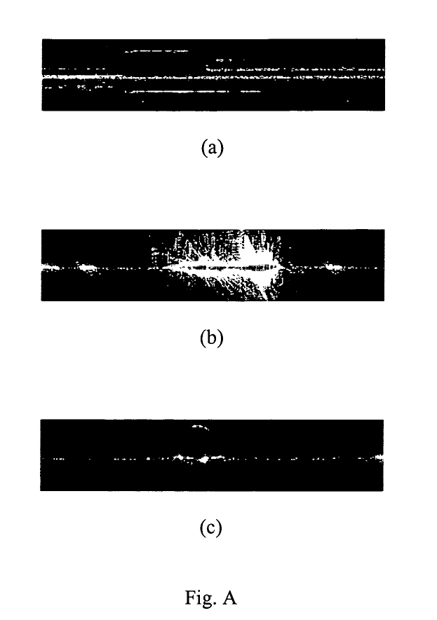

FIG. 1(a) is a prior art 3D image representation of a bare PCB, while FIG. 1(b) is a corresponding image for a process of the invention;

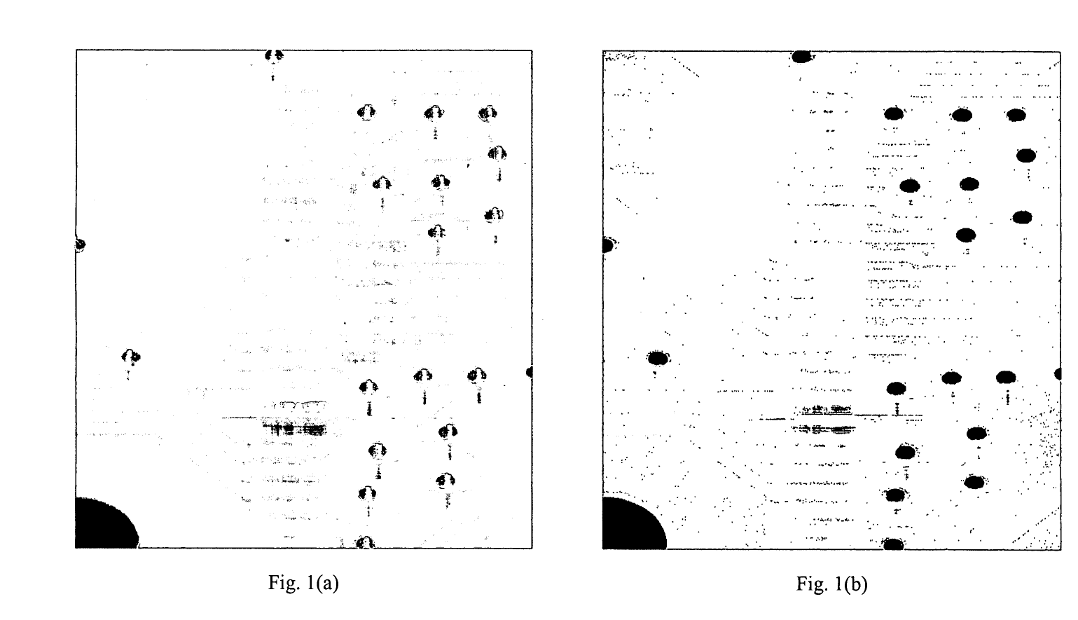

FIG. 2(a) is an image of the prior art of a laser line, while FIG. 2(b) is a corresponding image for a process of the invention;

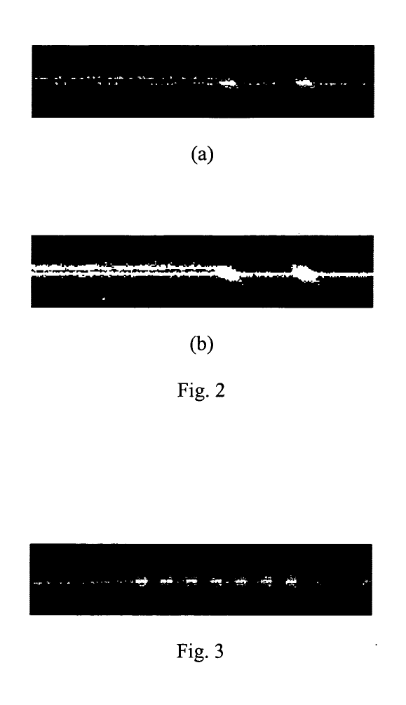

FIG. 3 is an image for illumination by a laser line crossing vertical tracks; and

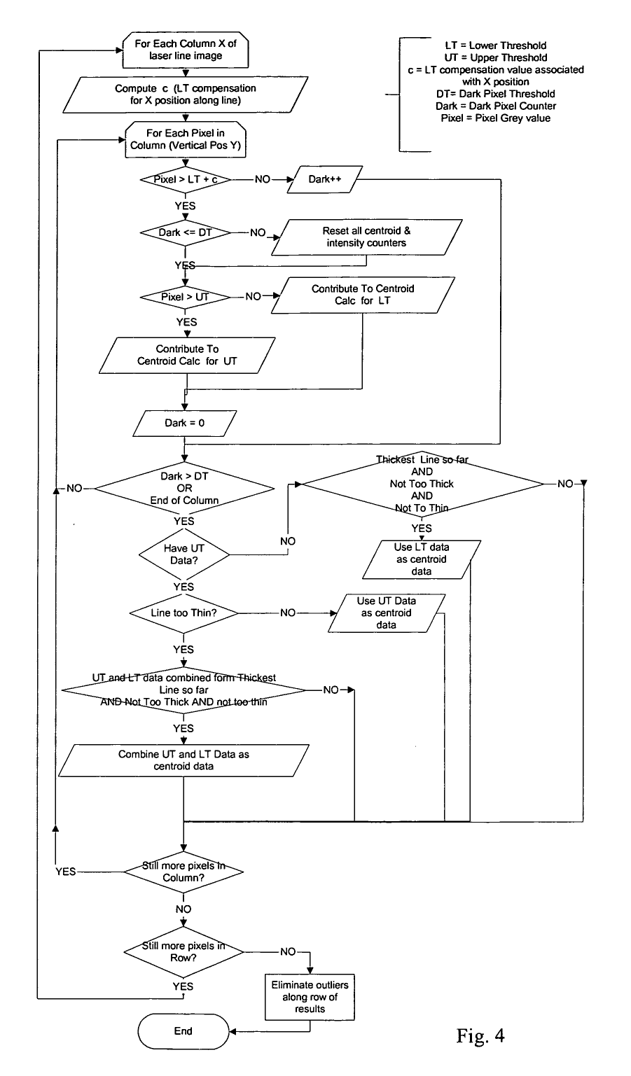

FIG. 4 is a flow diagram illustrating image processing flow.

In one embodiment, an image processor comprises an FPGA connected to a CMOS camera sensor. Referring to FIGS. 1(a) and 1(b) the considerable improvement in clarity for a process of the invention is illustrated. Most of the artefacts of the prior art image (FIG. 1(a)) have been eliminated. This is because of improved processing of laser line images.

The process uses a low grey threshold to determine the presence of laser line “bright” pixels along a column of the image WOI (window of interest). In general, it treats width of a line (number of pixels above a threshold across the line) as being an important indicator of a laser line. Where there are multiple lines, the widest one is chosen.

Valid Line Cross-Section Criteria

The process counts “dark” pixels (those whose grey levels are less than or equal to the lower threshold) and may join two separate runs of laser “bright” pixels in the column so long as the run of “dark” pixels between them is less than a “dark threshold”. FIG. 2 illustrates this. We have found that two pixels is a suitable “dark threshold” in general.

In FIG. 2(a) application of dark pixel threshold is illustrated in a laser line image. In FIG. 2(b) the image is thresholded to show pixels above lower grey threshold. There is a slightly split line on the left. If the vertical gap between the two parallel lines is less than or equal to the dark pixel threshold they will be considered as one line.

Since metallic surfaces (tracks, pads, paste, etc.) tend to reflect a high intensity of light (see FIG. 3), an upper threshold is used to identify these regions without mistake. Along the laser line these tend to show up as 2+ pixel thick lines of intensity in excess of ˜200 grey levels. If such a run is encountered then this is considered to be the line cross-section for that column and the process can be configured so that the rest of the column is not considered.

FIG. 3 shows a laser line crossing some vertical tracks. There is higher intensity of light reflected from the tracks.

There is an upper and lower configurable limit to the thickness of the line allowed. These limits exist separately for runs of pixels above the upper threshold and those above the lower threshold. Line cross-sections exhibiting thickness outside these limits will not be considered. An extreme example of where this validity criterion is useful can be seen in Fig. A(b) where the image is bloomed out so much that the line cross-section is unfeasibly thick.

The direction in which a column is searched can have a subtle effect on the outcome of the result due to the laser angle and although the thickest line cross-section is generally sought, ambiguity arises when line cross-sections of similar thickness to one another appear in the same column—in which case the first one encountered is generally used.

Centroid Calculation

For a valid line cross-section the centroid is computed thus:

$$\frac{{\sum }_{y = Start}^{y <= End} g ( x , y ) ( y + 1 )}{{\sum }_{y = Start}^{y <= End} g ( x , y )} , ∀ xy ( 0 <= x < M \& g ( x , y ) > T ) \qquad Eq . 1$$

where x represents the column being processed and is constant for any one column.
Start represents the start of the valid range of y positions associated with the valid line cross-section.
End represents the end of the valid range of y positions associated with the valid line cross-section.
N represents the number of lines in the WOI.
M represents the width of the WOI, which in this case is the width of the sensor.
T represents the grey threshold above which a grey value is considered to be part of the laser line. T can be one of two values, the upper threshold or the lower threshold. Its value will depend on the application of the valid line cross-section criteria above.
   Bit Storage Requirement:
   Numerator Bit Requirement:

Let the Maximum possible value of g(x, y) be MaxGrey

MaxGrey*1+MaxGrey*2+ . . . +MaxGrey*N

[symbol] MaxGrey*(1+2 + . . . +N)

[symbol] MaxGrey*(N²+N)/2

when MaxGrey=255 (as in the case of unsigned byte), and N=64 (typical height of WOI)

[symbol] 255*2080

[symbol] 530400

[symbol] No bits=>Log 530400/Log 2

[symbol] ˜20 bits

Denominator Bit Requirement

Once again, let the Maximum possible value of g(x, y) be MaxGrey

MaxGrey+MaxGrey+ . . .

[symbol] MaxGrey*N

when MaxGrey=255, N=64

[symbol] 255*64

[symbol] 16320

[symbol] No bits=>Log 16320/Log 2

[symbol] ˜14 bits

The output is expected to be 8 bits per column.

Since the height of the WOI is, at most, 64 pixels, the summation of the product of grey and row position for a column would require up to 20 bits. Similarly the summation of grey values would require up to 14 pixels. The division above would thus yield a 6 bit result, which would cost 2 bits of otherwise achievable precision, and yield a centroid value with single pixel precision rather than ¼ pixel precision. In order to recover these 2 bits of precision, the summation of the product of grey and row position is shifted to the left by 2 bits in advance of the division. The Summation thus yields a value of up to 22 bits. When this is divided by the 14 bit summation, the result is an 8 bit value comprising 6 bits for pixel precision and a further 2 bits of sub-pixel precision.

Laser Line Intensity Compensation Across Field of View

In general, the intensity response of the laser appears to be non-uniform across the field of view of the sensor. Typically the intensity of the beam tends to be greater in the centre of the line and appears to gradually fall-off as the line extends to the left or right. The lower intensity threshold is typically set to a value that will pick up the lowest intensity present that is likely to represent part of the reflected laser line so that as much data as possible representing the surface being scanned can be included. For the significantly higher intensity encountered gradually as one approaches the centre of the line, one might want to have control over the threshold used in this region. For example the intensity levels of the unwanted noise caused by scattered light are likely to be higher in intensity, and more likely to be used in the image processing. The processor can, however, compensate for this to an extent by varying the lower threshold across the field of view.

The simplest model is a linear one that increases from zero on the left side of the WOI to a configurable maximum or minimum, C, at the centre of the WOI and decreases gradually back to zero on the right side of the WOI. This can be represented by a simple function of the x position along the WOI. Thus for a particular horizontal position x along the WOI, one can compute a threshold compensation value, c, see Eq. 2 and Eq 3. As can be seen, there are two variants of the equation, the first one simply deals with the increasing part of the function, and the second deals with the decreasing part. The resulting compensation value is added to the lower threshold to compensate for the greater intensity towards the centre of the line. So referring back to Eq. 1, the value of T is increased by c if and only if T is the lower threshold. The central maximum compensation value, C, is configurable to allow for the possibility of different responses from different surface materials being scanned.

$$\begin{matrix}c = \frac{2 Cx}{M} , ∀ x ( 0 <= x < \frac{M}{2} ) & Eq . 2 \\ c = \frac{2 C ( M - x )}{M} , ∀ x ( \frac{M}{2} <= x < M ) & Eq . 3\end{matrix}$$

Intensity Calculation

The intensity data for a single column is computed using the sum of the grey values that are above the threshold. This sum is computed as part of the centroid calculation stage above. The count of the number of pixels comprising the corresponding laser-line cross-section is also recorded at that stage.

It would be most correct to compute the exact average intensity of the laser line pixels in the column, involving a division by an arbitrary number (as opposed to the simpler division by a power of two which may be implemented by bit shifts). The centroid calculation means that up to M (camera sensor width) divisions have to occur per WOI. If the intensity were also computed using arbitrary divisions, this would double the amount of divisions required per WOI.

Elimination of Outliers

Outliers along the laser profile may be caused by, among other things, scattered light (see Fig. A(c)). In the invention such effects are reduced by keeping track of the average result over the last N pixels to the left of any one column result and using a transition threshold (in pixels) to determine whether or not this value should be used or left out of the final result. One would expect that a small overestimation of the maximum expected feature height (for example, solder paste height) would serve as the basis for a good threshold here. Of course any transition that is not valid but falls within the threshold will not be successfully eliminated—this is unavoidable. The number of pixels to use in this partial mean is configurable, but must be a power of 2 to simplify the division required. It is because of this that the parameter is specified by the power itself, e.g. 2 indicates that 4 pixels must be used, 3 indicates that 8 pixels must be used, etc.

Mean of Line

The mean of the centroids for the entire width of the WOI is computed and stored as the last (rightmost) byte of the line of results output by the FPGA. The difference is however that in this case only those values that are non-zero are considered. The advantage of this is that the mean is more likely to represent the average level of the PCB along that line, rather than incorporating holes in the data that would inappropriately bias the data. Unfortunately this introduces a division by an arbitrary number which may be different per laser profile depending on the amount of zero data present. In order to eliminate this complexity, but maintain as much as possible the integrity and meaningfulness of the result, it is necessary to make sure that only divisions by a power of 2 are performed.

The approach taken is that as the centroids are summed and counted across the array, every time a power of 2 is reached by the count, the summation is backed up along with the power concerned. At the end of the summation, the most recently encountered power of two will be used as the divisor (the power itself will be used to shift the digits) and the corresponding backed up summation will be dividend. The impact of this is that for a sensor width of 2352 say, only up to 2048 values can be used, and if there are less than 2048 values that are above zero, 1024 will only be used, etc. The upside is that, in many cases there should be few zero data points, the division will be simpler and faster for the FPGA to carry out, and the integrity of the resulting mean will be minimally compromised.

Referring to FIG. 4 the image processing method described above is illustrated in flow chart format. It will be noted that both the upper and lower thresholds are used, and there is compensation of the lower threshold for intensity variation across the width of the laser line. Also, there are separate centroid calculations for the pixels in the two bands. The dark pixel level is reset to zero and is dynamically updated. Also, the LT and UT data is combined to check if they form the thickest line so far.

The invention is not limited to the embodiments described but may be varied in construction and detail.

1. An image processor for capturing camera sensor signals and identifying patterns of illumination on a target, wherein the processor identifies a most probable illumination line from a plurality of lines which include spectral reflections from surfaces adjacent to a central line of illumination.

2. An image processor as claimed in claim 1, wherein the processor identifies as most probable the line of pixels which is the widest.

3. An image processor as claimed in claim 2, wherein the processor imposes upper and lower limits on line width.

4. An image processor as claimed in claim 3, wherein said limits are configurable.

5. An image processor as claimed in claim 3, wherein the upper limit is set to eliminate blooming.

6. An image processor as claimed in claim 1, wherein the processor determines a gap between parallel lines separated by dark pixels and processes two parallel lines as a single line if the distance between them is below a threshold.

7. An image processor as claimed in claim 6, wherein the threshold is two dark pixels.

8. An image processor as claimed in claim 1, wherein the processor compares pixel values against a threshold to identify a line.

9. An image processor as claimed in claim 8, wherein the processor varies the threshold across the field of view.

10. An image processor as claimed in claim 9, wherein the threshold is a function of a dimension of the field of view.

11. An image processor as claimed in claim 10, wherein the threshold is varied by adding a compensation value according to a dimension value.

12. An image processor as claimed in claim 9, wherein the threshold is increased or reduced closer to the centroid of a line.

13. An image processor as claimed in claim 8, wherein the processor compares pixel values against lower and upper thresholds.

14. An image processor as claimed in claim 13, wherein results of one or both comparisons are used in centroid calculations.

15. An image processor as claimed in claim 14, wherein pixels above the upper threshold are used in the centroid calculations in preference if there are sufficient such pixels.

16. An image processor as claimed in claim 1, wherein the processor eliminates outlier pixels by:
keeping track of an average pixel level, and
comparing a pixel value with the average level to estimate if it is an outlier.

17. A machine vision system comprising:
an illuminator for directing linear illumination at a target,
a camera, and an image processor of claim 1 connected to the camera.
